(19) United States
(12) Patent Application Publication
(10) Pub. No.: US 2018/0064117 A1
(43) Pub. Date: Mar. 8, 2018

(54) METHOD OF PREPARING AND SERVING A SANDWICH

(71) Applicant: ORGANIC TRAILS CAFES LLC, Columbus, OH (US)

(72) Inventors: Elizabeth JONES, Columbus, OH (US); Sean JONES, Columbus, OH (US); Kevin MALHAME, Columbus, OH (US)

(21) Appl. No.: 15/686,428

(22) Filed: Aug. 25, 2017

Related U.S. Application Data
(60) Provisional application No. 62/385,015, filed on Sep. 8, 2016.

(51) Int. Cl. A21D 13/32

(52) U.S. Cl. CPC A21D 13/32

(57) ABSTRACT

A method of preparing and serving a sandwich involves providing a ring, providing a pita, opening the pita to expose a pocket, placing the pita into the ring, filling the pocket with foodstuffs, and serving the assembled sandwich, in the ring, to a diner.

### CROSS REFERENCE TO RELATED APPLICATION

This application claims benefit under 35 U.S.C. § 119 of U.S. Provisional Patent Application No. 62/385,015, filed on Sep. 8, 2016, and incorporates by reference the disclosure thereof in its entirety.

### BACKGROUND AND SUMMARY OF THE DISCLOSURE

A pita is a flexible flatbread, typically made from flattened rounds of dough. When baked, the rounds of dough puff up dramatically. When removed from the oven and cooled, layers of baked dough may remain separated, thereby forming a pocket within the pita. The pita can be opened, thereby exposing the pocket. For example, the pita may be torn, sliced, or otherwise cut crosswise, like a pie, to form portions of a circle (or another shape the pita may have assumed during its preparation). Alternatively, the pita may be torn, sliced, or otherwise cut edgewise, that is, inwardly from a circumferential edge of the pita, perpendicular to its flat surfaces.

The opened pita may be filled with any desired foodstuff(s) to make a sandwich. The filled pita may be served to a diner to be eaten. Maintaining the pita in an opened state while filling it can be challenging.

### BRIEF DESCRIPTION OF THE DRAWINGS

FIG. 1 is a perspective view of a pita;

FIG. 2 is a perspective view of the pita of FIG. 1 in a liner;

FIG. 3 is a perspective view of the pita of FIG. 1 sliced edgewise;

FIG. 4 is a perspective of the pita of FIG. 3 opened to expose a pocket therein;

FIG. 5 is a perspective view of the opened pita of FIG. 4 disposed within a ring having an open top and an open bottom;

FIG. 5A is a perspective view of the opened pita of FIG. 4 disposed within an alternative ring having an open top and an open bottom

FIG. 6 is a perspective view of the opened pita and ring of FIG. 5 with the pita filled with foodstuffs; and

FIG. 7 is a perspective view of the filled pita and structural ring of FIG. 6 with the ring disposed on a plate.

### DETAILED DESCRIPTION OF THE DRAWINGS

The drawings show an illustrative method of making and serving a sandwich.

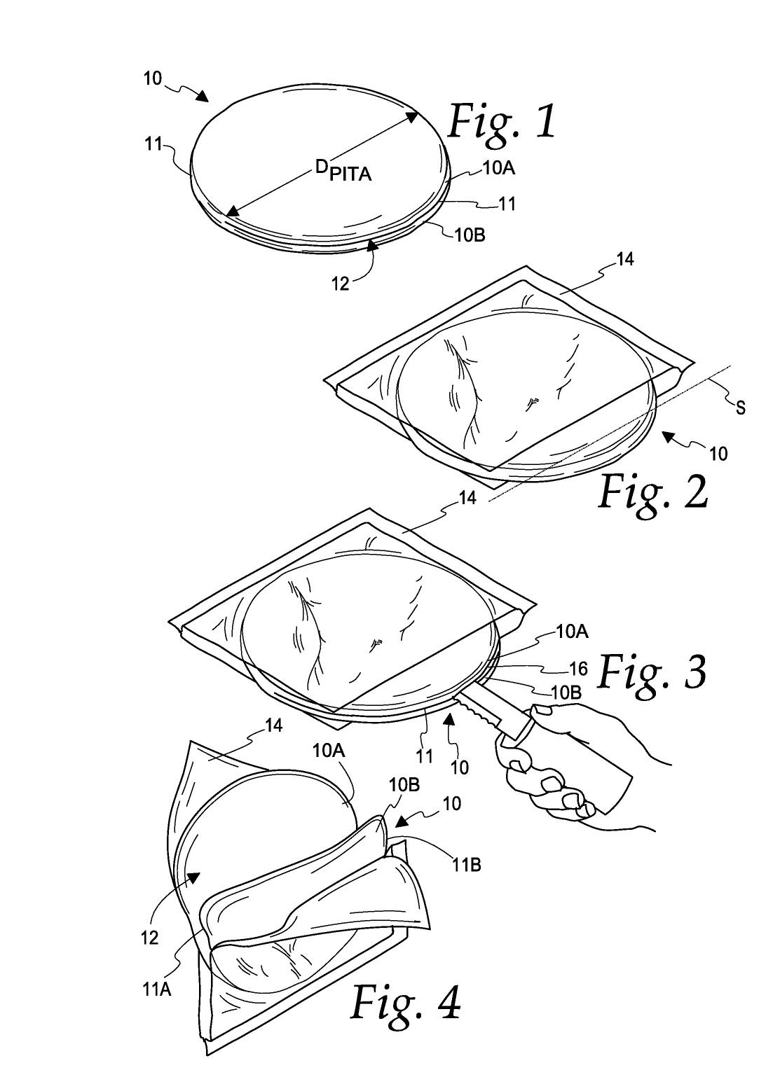

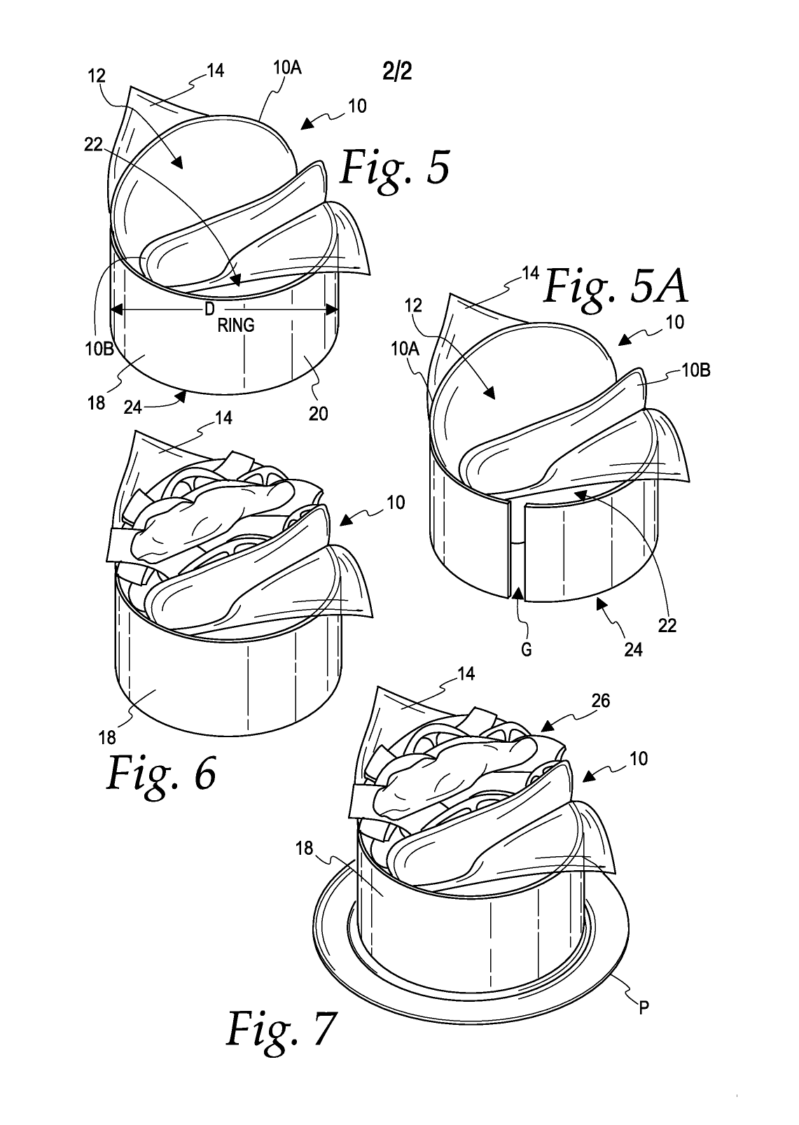

FIG. 1 shows an illustrative pita 10. The pita 10 is generally round and flat and defines a circumferential edge 11. The pita 10 has a diameter (or minor diameter, if out of round) Dₚᵢₜₐ. With reference to FIGS. 4, 5, and 5A, the pita 10 incudes a first layer 10A and a second layer 10B joined to the first layer at the edge 11. The first layer 10A and the second layer 10B cooperate to define an interior pocket 12.

The pita 10 may be placed into a liner 14, for example, as shown in FIG. 2. The liner 14 may be, for example, an envelope or sheet of material made of food service-grade tissue or foil. A portion of the pita 10 may be exposed from the liner 12 for aesthetics and to facilitate slicing and filling of the pita with foodstuffs, as discussed further below. The pita 10 may be placed into the liner 14 before or after forming an opening in the pita, as discussed further below. In an embodiment, the liner 14 may be omitted.

As shown in FIG. 3, the pita 10 may be sliced edgewise (that is, between the first layer 10A and the second layer 10B) with a knife to locally separate the first layer 10A from the second layer 10B at the edge 11, thereby forming an opening 16, the opening providing access to the interior pocket 12 from the exterior of the pita. In other embodiments, the opening 16 may be formed by otherwise slicing, cutting, or tearing the pita 10 edgewise. In further embodiments, the opening 16 may be formed by otherwise slicing, cutting, or tearing the pita 10. For example, the opening 16 may be formed by slicing, cutting, or tearing the pita 10 along and through a secant line S (see FIG. 2) thereof, thereby trimming off a peripheral portion of the pita. The opening 16 may be enlarged while spreading the first and second layers 10A, 10B of the pita 10 apart from each other and/or filling the pita with foodstuffs, as will be discussed further below.

FIG. 4 shows the first and second layers 10A, 10B of the pita 10 spread apart from each other proximate the opening 16, thereby exposing the interior pocket 12. The first and second layers 10A, 10B may be spread apart from each other, for example, by imparting opposing forces on the first and second layers using tongs, another tool or utensil, or a user's hands.

As the first and second layers 10A, 10B are spread apart from each other, opposing portions 11A, 11B of the edge 11 may be drawn toward each other in a direction generally perpendicular to the direction in which the first and second layers are spread apart from each other. Consequently, the opening 16 may take on a generally circular shape.

FIG. 5 is a perspective view of the pita 10 with the first and second layers 10A, 10B thereof placed within a ring 18, with a closed portion of the pita, that is, a portion of the pita where the first and second layers remain joined, facing into the ring. In an embodiment, the pita 10 could be sliced completely through and the resulting halves of the pita placed into the ring 18. Typically, however, the first and second layers 10A, 10B would remain joined over about 50% of the diameter Dₚᵢₜₐ of the pita, or about 45%-55% of the diameter of the pita, or about 35%-65% of the of the diameter of the pita, or about 25%-75% of the diameter of the pita.

The ring 18 is shown as annular, having a sidewall 20, an open top 22, and an open bottom 24. The ring has a diameter (or major diameter if out of round) D_{ring} and a height H. The height H and diameter D_{ring} may be selected to enable the ring 18 to hold the pita 10 placed therein in an open position (that is, with the first and second layers 10A, 10B spread apart from other, thereby exposing the interior pocket 12) without external assistance, for example, by a person filling the opened pita with foodstuffs, as will become apparent from the discussion below. For example, an upper edge of the sidewall 20 of the ring 18 may support opposing portions of the edge 11 of the pita 10. As such, the diameter D_{ring} of the ring 18 typically would be less than the diameter Dₚᵢₜₐ of the pita 10. The height H may be approximately equal to the diameter Dₚᵢₜₐ. In other embodiments, the height may be about 50% to 150% or 75% to 125% of the diameter Dₚᵢₜₐ. In further embodiments, the ratio of the height H to the diameter Dₚᵢₜₐ may be selected as desired.

In an embodiment, the ring 18 could have a shape other than annular. For example, the ring 18 could be embodied as a triangle, a square, or other polygonal structure having a sidewall including n sides, an open top, and an open bottom. The sides could have generally equal or unequal dimensions and be joined at generally equal or unequal internal angles. The ring 18 could assume other symmetrical or asymmetrical shapes, as well.

As shown in FIG. 5, the sidewall 20 of the ring 18 may be continuous and unbroken. Alternatively, as shown in FIG. 5A, the sidewall 20 of the ring 18 may be discontinuous, thereby defining a gap G in the sidewall 20.

In an embodiment, the ring 18 may be replaced with an otherwise similarly-shaped container having a sidewall, an open top, and a closed bottom.

The ring 18 may be made of any suitable material enabling repeated washing and reuse of the ring, for example, brass, stainless steel, earthenware, or plastic, among others. In other embodiments, the ring 18 may be made of other materials. In an embodiment, the ring 18 could be made of a disposable material, for example, paper or card stock. In any event, the ring 18 typically would be constructed so as to substantially retain its shape without any external force applied thereto.

The first and second layers 10A, 10B of the pita 10 may be at least partially spread apart from each other before placing the pita into the ring 18. In such an embodiment, the first and second layers 10A, 10B of the pita 10 may be further spread apart from each other after placing the pita into the ring 18.

In an embodiment, the first and second layers 10A, 10B of the pita 10 may be spread apart from each other upon placement of the pita into the ring. In such an embodiment, the first and second layers 10A, 10B of the pita 10 may be further spread apart from each other after the pita has been placed into the ring.

In an embodiment, the first and second layers 10A, 10B of the pita 10 may be spread apart from each other after the pita has been placed into the ring 18.

With the first and second layers 10A, 10B of the pita 10 spread apart from each other, the pita 10 may be filled with one or more foodstuffs 26 as shown in FIG. 6. The foodstuffs 26 may include, without limitation, meats, vegetables, grains, sauces, and condiments, in any combination. The foodstuffs 26 may be sized to facilitate their placement into the pocket and to facilitate their consumption by a diner without use of a knife.

As shown in FIG. 7, the ring 18 may be placed on a plate P, a tray, or another structure generally underlying the open bottom of the ring and supporting the ring. Although FIG. 7 shows the filled pita 10 in the ring 18, the ring could be placed on the plate P while empty.

Any or all or the foregoing steps may be performed manually by a user. The user may employ one or more suitable tools as may be necessary or desired. In an embodiment, any or all of the foregoing steps may be performed by or with the assistance of suitable automated equipment. The foregoing steps may be performed in any sequence to the greatest extent possible.

1. A method of preparing and serving a sandwich, comprising the steps of:
providing a ring having a sidewall, an open top, and an open bottom;
providing a pita, the pita having sides defining an interior pocket;
opening the pita to expose the pocket;
spreading apart the sides of the pita to further expose the pocket;
placing a closed end of the pita into the ring so that the exposed pocket faces outwardly from the ring;
filling the pocket with foodstuffs; and
serving the filled pita, in the ring, to a diner.

2. The method of claim 1, wherein the step of opening the pita comprises slicing the pita.

3. The method of claim 1, wherein the step of opening the pita comprises slicing the pita edgewise or crosswise.

4. The method of claim 1, wherein the ring has a height and a diameter and the height of the ring is approximately equal to the diameter.

5. The method of claim 1 further comprising the step of placing the pita into a liner.

6. The method of claim 4 wherein the liner is food service grade tissue or foil.

7. The method of claim 1 further comprising the step of placing the ring onto a structure covering the open bottom of the ring.

8. The method of claim 7 wherein the structure comprises a tray or a plate.
